(19) United States
(12) Patent Application Publication
(10) Pub. No.: US 2013/0047939 A1
(43) Pub. Date: Feb. 28, 2013

(54) EFFICIENT ENERGY RECOVERING AIR INLET SYSTEM FOR AN INTERNAL COMBUSTION ENGINE

(71) Applicants: Michael Dirk Boot, Veldhoven (NL); Ruud Henricus Lambertus Eichhorn, Asten (NL)

(72) Inventors: Michael Dirk Boot, Veldhoven (NL); Ruud Henricus Lambertus Eichhorn, Asten (NL)

(73) Assignee: PROGRESSION-INDUSTRY B.V., EINDHOVEN (NL)

(21) Appl. No.: 13/695,834

(22) PCT Filed: May 3, 2011
(86) PCT No.: PCT/EP11/57030

§ 371 Date: Nov. 2, 2012

(30) Foreign Application Priority Data
May 5, 2010 (EP) 10162000.3

(51) Int. Cl. F02B 63/04

(52) U.S. Cl. 123/2

(57) ABSTRACT

An air inlet system (10) for an internal combustion engine (200) is provided. The air inlet system comprises an air intake port (20), an air output port (30) for providing air for a combustion chamber (202) of the combustion engine (200), and a turbine (40). The turbine (40) is situated in between the air intake port (20) and the air output port (30) for turning kinetic energy of an airstream from the air intake port (20) to the air output port (30) into mechanical energy. The turbine (40) comprises at least one adjustable vane (48) for controlling an air flow resistance of the turbine (40). An electrical generator (46) is coupled to the turbine (40) for converting the mechanical energy into electrical energy. A controller (60) controls a rotational speed of the turbine (40) by controlling a quantity of electric power generated by the electrical generator (46), the controller (60) being configured to adapt the rotational speed of the turbine (40) to the air flow resistance of the turbine (40) in such a way that a substantially optimal turbine efficiency is obtained.

### FIELD OF THE INVENTION

This invention relates to an air inlet system for an internal combustion engine, the air inlet system comprising an air intake port, an air output port, a turbine, an electrical generator and a controller. The air output port provides air to a combustion chamber of the combustion engine. The turbine is situated in between the air intake port and the air output port for turning kinetic energy of an airstream from the air intake port to the air output port into mechanical energy. The turbine comprises at least one adjustable vane for controlling an air flow resistance of the turbine. The electrical generator converts the mechanical energy into electrical energy and the controller controls a rotational speed of the turbine by controlling a quantity of electric power generated by the electrical generator.

This invention further relates to an internal combustion engine comprising such an air inlet system.

This invention also relates to a method of controlling an air inlet system and a computer program product for performing said method.

### BACKGROUND OF THE INVENTION

Such an air inlet system is known from the international patent application published as WO 2009/092670, wherein such a turbine in the air inlet is used for generating energy for propelling one or more engine appendages, such as a steering pump which is usually driven by the crank shaft. The cooled air from the turbine is also used in a heat exchanger which is part of a system for controlling a temperature inside the vehicle using the internal combustion engine. An alternator is coupled to the turbine for converting the mechanical energy of the turbine into electrical energy.

WO 2009/092670 discloses two mechanisms that influence the air flow resistance of the turbine. When the engine has to deliver high loads, the air flow resistance is reduced. High air flow resistance corresponds to reduced engine power situations. The turbine comprises adjustable vanes to control the airflow through the turbine. The position of the vanes may be adjusted to increase or decrease the air flow resistance of the turbine in conjunction with the engine load. Alternatively, the alternator may be used for controlling the rotational speed of the turbine by controlling a quantity of electric power the alternator generates. Higher rotational speeds corresponds to high air flow resistance and low engine power situations. When the amount of electrical energy extracted from the alternator increases, the rotational speed of the turbine is reduced. The reduced air flow resistance situation results in increased engine power.

It is a disadvantage of the air inlet system of WO 2009/092670 that it may result in situations with conflicting configuration preferences. For instance, in situations of high engine load and high need for electrical energy, the position of the vanes should be adjusted to reduce air flow resistance (high engine load) while the alternator should be configured to increase air flow resistance (high electrical energy demand). The main problem of the known air inlet system is that controlling the load on the alternator by changing the rotational speed of the turbine, influences the efficiency of the turbine and the alternator.

### OBJECT OF THE INVENTION

It is an objective of the invention to provide an air inlet system as described in the opening paragraph with an improved air flow resistance regulation.

### SUMMARY OF THE INVENTION

According to a first aspect of the invention, this object is achieved by providing an air inlet system for an internal combustion engine, the air inlet system comprising an air intake port, an air output port, a turbine situated in between the air intake port and the air output port, an electrical generator coupled to the turbine and a controller for controlling a rotational speed of the turbine. The air output port provides air to a combustion chamber of the combustion engine. The turbine turns kinetic energy of an airstream from the air intake port to the air output port into mechanical energy and comprises at least one adjustable vane for controlling an air flow resistance of the turbine. The electrical generator converts the mechanical energy into electrical energy. The controller controls the rotational speed of the turbine by controlling a quantity of electric power generated by the electrical generator. The rotational speed of the turbine is adapted to the air flow resistance of the turbine in such a way that a substantially optimal turbine efficiency is obtained.

The inventors have found that the efficiency of the turbine depends on a parameter that is usually called the ‘blade speed ratio’. The blade speed ratio is a ratio of a first term depending on the rotational speed of the turbine and a second term depending on the pressure drop over the turbine. High rotation speeds and small pressure drops (high engine load) lead to a high blade speed ratio. Low rotation speeds and high pressure drops (low engine load) lead to a high blade speed ratio. The current invention uses the insight that for every available vane configuration, there is an optimal blade speed ratio leading to the highest turbine efficiency. Because the blade speed ratio depends on the rotational speed of the turbine, the turbine efficiency can be maximized by adapting the rotational speed of the turbine to the air flow resistance or vane configuration of the turbine.

The adaptation of the rotational speed of the turbine may be based on information about the vane configuration and a list or table with optimal blade speed ratios for different vane configurations. Alternatively or additionally a control loop may be used. The control loop comprises means for determining the turbine efficiency and means for adapting the blade speed ratio. When the blade speed ratio is changed, the effect on the turbine efficiency is determined and the blade speed ratio is changed again in order to increase the turbine efficiency. This process may be repeated until an optimal turbine efficiency is obtained.

According to a further aspect of the invention, an internal combustion engine is provided comprising an air inlet system as described above for providing air for a combustion chamber of the engine.

These and other aspects of the invention are apparent from and will be elucidated with reference to the embodiments described hereinafter.

### BRIEF DESCRIPTION OF THE DRAWINGS

In the drawings:

FIG. 1 schematically shows an internal combustion engine with an air inlet system according to the invention,

FIGS. 2a and 2b show a turbine of an air inlet system in two different configurations,

FIG. 3 shows a relation between blade speed ratio and turbine efficiency, and

FIG. 4 shows a control loop for optimizing the turbine efficiency.

### DETAILED DESCRIPTION OF THE INVENTION

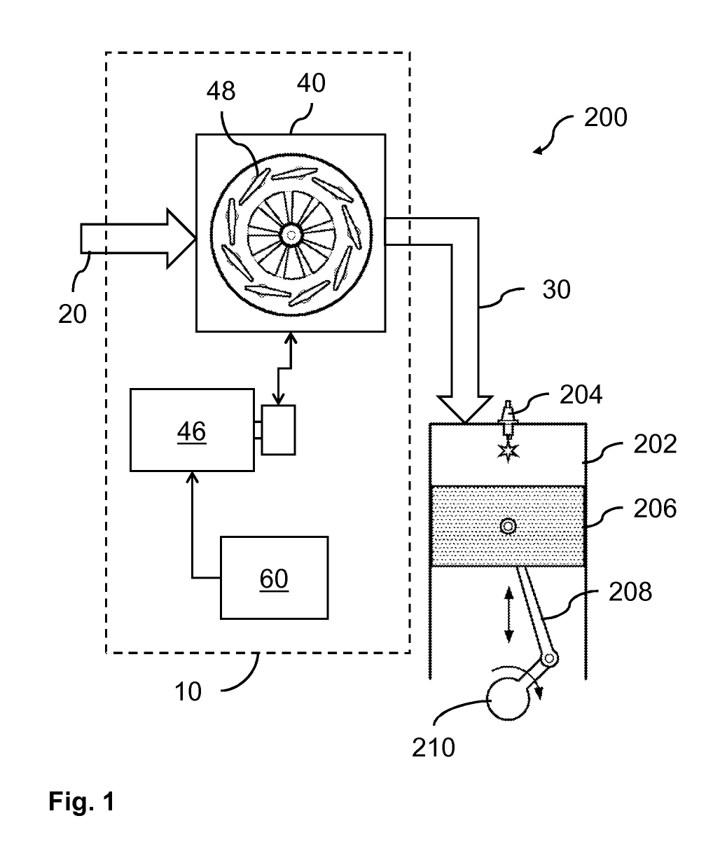

FIG. 1 schematically shows a spark-ignition engine 200 with an air inlet system 10 according to the invention. The engine 200 comprises a combustion chamber 202 which comprises a piston 206 connected to a crankshaft 210 via a piston rod 208. The engine 200 further comprises a spark plug 204 for providing a spark for igniting the air-fuel mixture and apply a force on the piston 206 which moves away from the spark-plug 204. The movement of the piston 206 is converted via the piston rod 208 into a rotational movement of the crankshaft 210.

Known spark-ignition engines typically comprise a three-way catalyst (not shown) for reducing the emission of carbon monoxide, unburned hydrocarbons and nitrogen oxides from the spark-ignition engine. This catalyst requires a substantially constant air-fuel ratio of approximately 14.7:1 for proper operation. The engine power in the known spark-ignition engines is typically regulated by regulating the air mass flow into the combustion chamber of the engine. The air mass flow is generally varied by varying the air intake pressure near the cylinder of the known combustion engine using a throttle valve between an air inlet of the combustion chamber and ambient air. Due to the pressure difference across the valve, the air expands when passing the valve. However, in the known spark-ignition engines the expansion process of the air coincides with frictional heating of the expanding air which results in a substantially isenthalpic process in which the reduction of the air temperature due to the expansion is annulled by the heating of the air due to friction. This results in energy being wasted.

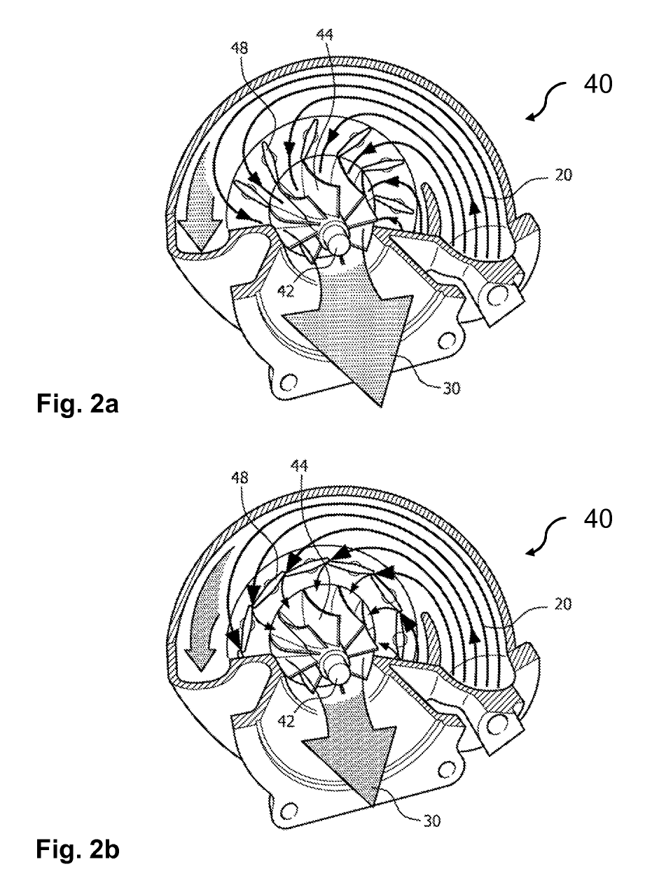

In W0 2009/092670 the energy waste is reduced by replacing the valve by a turbine 40 in the air inlet system 10. The function of the turbine 40 is to convert (part of) the wasted energy of the expanding air into mechanical energy of the blade 44 (see FIGS. 2a and 2b). The mechanical energy is then reused. In such a spark-ignition engine 200, the spark-ignition engine 200 comprises an air inlet system 10 for controlling the air mass flow into the combustion chamber 202. The air inlet system 10 comprises a turbine 40 provided with an impeller hub 42 (see FIGS. 2a, 2b) which comprises at least one blade 44 (FIGS. 2a, 2b). The air inlet system 10 comprises an air intake port 20 through which the air enters the air-inlet system 10, and comprises an air output port 30 via which the air is provided to the combustion chamber 202 of the spark-ignition engine 200. The air inlet system 10 is configured to guide air from the air intake port 20 via the turbine 40 to the air output port 30. Between the air output port 30 and the combustion chamber 202 a manifold 50 and fuel inlet means may be provided. The turbine 40 enables to control the air mass flow into the combustion chamber 202 while using at least some of the pressure drop across the turbine 40 to drive the blade 44 of the turbine 40 for generating mechanical energy.

The mechanical energy of the blade 44 of the turbine 40 may, for example, be used to propel or to provide energy for propelling one or more engine appendages. Examples of such engine appendages are a power steering pump (not shown) or a generator (alternator or dynamo) 46 for converting the mechanical energy into electric energy. When varying the load on the generator 46 by extracting more or less energy from it, the rotational speed of the turbine 40 changes. When less electrical energy is extracted from the generator 46, the turbine 40 rotates faster and the mass flow rate in the turbine 40 decreases (increased air-flow resistance). According to the invention and as will be elucidated below, the rotational speed of the generator 46 is controlled by a controller 60 in order to optimize the turbine efficiency.

One or more adjustable vanes 48 are provided for regulating the air-flow through the turbine 40. Below, with reference to FIGS. 2a and 2b, it is elucidated how adjustment of the vane positions is used to control the air-flow resistance and therewith also the air intake pressure and mass flow rate.

FIGS. 2a and 2b show a turbine 40 of an air inlet system 10 in two different configurations. The turbine 40 comprises an impeller hub 42 with one or more impeller blades 44 which are propelled by the air passing through the turbine 40. The air enters the turbine 40 through air intake port 20 and leaves the turbine 40 at the air output port 30. The adjustable vanes 48 regulate the air-flow through the turbine 40 and determine the air-flow resistance.

In FIG. 2a a first orientation of the adjustable vanes 48 is shown in which the adjustable vanes 48 are adjusted such that the air can flow through the turbine 40 relatively easily, resulting in a relatively low air-flow resistance of the turbine 40. This first orientation of the adjustable vanes 48 generally represents high engine loads and/or speed (=high power). The vanes 48 as shown in the first orientation of the adjustable vanes 48 form an air nozzle with a relatively large flow area, which results in a relatively weak force being applied to the blades 44. The large flow area of the air nozzle formed by the pairs of adjacent vanes 48 allows the air to flow through the turbine 40 relatively easily and results in a relatively low air-flow resistance. This configuration is very suitable for high engine loads and leads to a reduced conversion of mechanical energy of the turbine 40 into electrical energy by the generator 46 (not shown).

FIG. 2b shows a second orientation of the adjustable vanes 48 in which the adjustable vanes 48 are adjusted such that the air is guided to hit the blades 44 at a relatively small incidence angle (near to the normal axis of the blades 44), which results in a relatively large force applied to the blades 44 for propelling the blades 44. This second orientation of the adjustable vanes 48 with the corresponding small flow area of the air nozzles results in a relatively high air-flow resistance of the turbine 40. This configuration is very suitable for low engine loads and leads to an increased conversion of mechanical energy of the turbine 40 into electrical energy by the generator 46 (not shown).

According to the invention, the efficiency of the turbine 40 is optimized by tuning the ‘blade speed ratio’. The blade speed ratio, U/C, is a ratio of a first term, U(ω), depending on the rotational speed (ω) of the turbine 40 and a second term, C(π), depending on the pressure drop (π) over the turbine 40. A possible formula (found in: Watson, N., ‘Turbocharging the internal combustion engine’, 1982, Wiley, New York) for the blade speed ratio is given by:

$$U ( ω ) \text{/} C ( π ) = \frac{U}{\sqrt{2 ( {h}_{01} - {h}_{5} )}} = \frac{U}{\sqrt{\{ 2 {C}_{p} \cdot {T}_{01} [ 1 - {( {p}_{5} \text{/} {p}_{01} )}^{( κ - 1 ) \text{/} κ} ] \}}} , \qquad ( 1 )$$

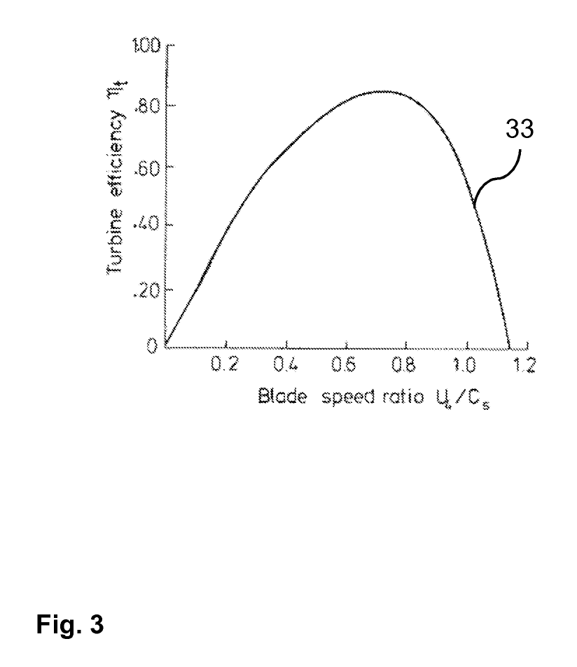

C represents a speed equivalent of the isoentropic expansion over the turbine 40 and depends on the configuration of the adjustable vanes 48. According to formula (1), high rotation speeds and small pressure drops (high engine load) lead to a high blade speed ratio. Low rotation speeds and high pressure drops (low engine load) lead to a low blade speed ratio. The current invention uses the insight that for every available vane configuration, there is an optimal blade speed ratio leading to the highest turbine efficiency (see FIG. 3). Because the blade speed ratio depends on the rotational speed of the turbine, the turbine efficiency can be maximized by adapting the rotational speed of the turbine to the air flow resistance or vane configuration of the turbine.

FIG. 3 shows a relation 33 between blade speed ratio U/C and turbine efficiency η (Watson, N., ‘Turbocharging the internal combustion engine’, 1982, Wiley, New York). The inventors have found out that this relation may change together with the configuration of the adjustable vanes 48. FIG. 3 thus shows the turbine efficiency 17 as a function of the blade speed ratio U/C for a specific configuration of the adjustable vanes 48. According to the invention this relation is used to improve the efficiency of the turbine 40. When the adjustable vanes 48 are configured in accordance with the required air flow resistance, the optimal blade speed ratio can be determined. By controlling the rotational speed of the turbine 40, the turbine 40 is configured to approach the optimal efficiency.

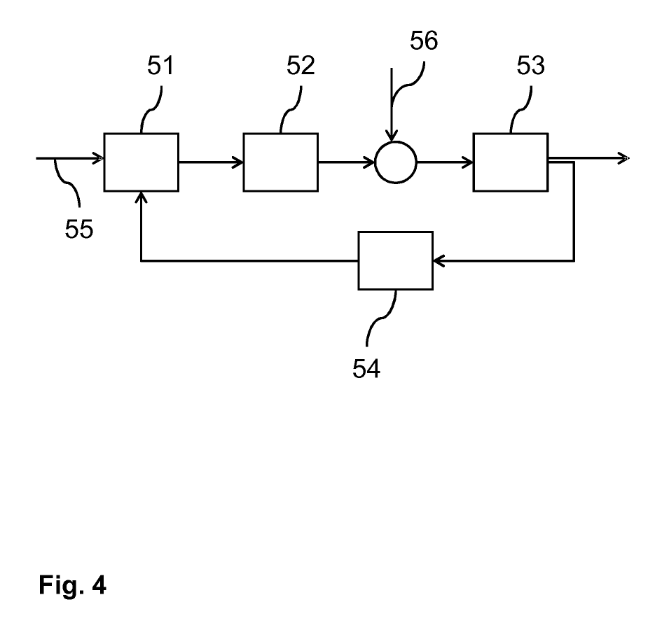

FIG. 4 shows an exemplary control loop for optimizing the turbine efficiency. The control loop is executed by the controller 60 of the air inlet system 10 of FIG. 1. The control loop uses reference speed 55 which may be derived from tables with U/C characteristics, preferably from tables with optimal blade speed ratios for the current configuration of the adjustable vanes 48. The reference speed may be calculated from known system parameters describing, e.g., a current pressure drop over the turbine 40, a current configuration of the adjustable vanes 48, a current temperature or known system characteristics. In comparison block 51, the current blade speed or rotational speed of the turbine 40 is compared to the reference speed 55. In control block 52, a control signal for the generator 46 is generated. If the current speed does not match the reference speed 55, the controller 60 increases or decreases the electrical load on the generator 46 accordingly. When the current speed is too low, the amount of electrical power derived from the generator 46 is reduced. When the current speed is too high, the amount of electrical power derived from the generator 46 is increased. The control signal from the controller 60 to the generator 46, together with other disturbances 56 influences rotation speed of the generator 46 and the amount of mechanical energy that is converted into electrical energy. The generator block 53 in the control loop represents the change of rotation speed caused by the control signal and the disturbances 56. In feedback block 54, a speed sensor measures the current blade speed or rotational speed of the turbine 40. This current speed is thereafter used in the comparison block 51 wherein it is compared to the reference speed 55. Optionally, the current speed is also used for adjusting the tables and formulas used for determining the reference speed 55. Instead of or in addition to measuring and adjusting the rotational speed of the turbine 40, the control loop may also measure the efficiency of the turbine 40. The sensor may, for example, measure the amount of electrical energy produced by the generator or a temperature difference over the turbine in order to determine the efficiency. When the control signal provided by the controller 60, it may be determined whether the efficiency is increased or decreased. When the effect of the most recent adaptation is known, the controller may be adjusted accordingly.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. It will also be appreciated that such a program may have many different architectural designs. For example, a program code implementing the functionality of the method or system according to the invention may be subdivided into one or more subroutines. Many different ways to distribute the functionality among these subroutines will be apparent to the skilled person. The subroutines may be stored together in one executable file to form a self-contained program. Such an executable file may comprise computer executable instructions, for example processor instructions and/or interpreter instructions (e.g. Java interpreter instructions). Alternatively, one or more or all of the subroutines may be stored in at least one external library file and linked with a main program either statically or dynamically, e.g. at run-time. The main program contains at least one call to at least one of the subroutines. Also, the subroutines may comprise function calls to each other. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth. These instructions may be subdivided into subroutines and/or be stored in one or more files that may be linked statically or dynamically.

The carrier of a computer program may be any entity or device capable of carrying the program. For example, the carrier may include a storage medium, such as a ROM, for example a CD ROM or a semiconductor ROM, or a magnetic recording medium, for example a floppy disc or hard disk. Further the carrier may be a transmissible carrier such as an electrical or optical signal, which may be conveyed via electrical or optical cable or by radio or other means. When the program is embodied in such a signal, the carrier may be constituted by such cable or other device or means. Alternatively, the carrier may be an integrated circuit in which the program is embedded, the integrated circuit being adapted for performing, or for use in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An air inlet system for an internal combustion engine, the air inlet system comprising:
an air intake port,
an air output port for providing air for a combustion chamber of the combustion engine,
a turbine situated in between the air intake port and the air output port for turning kinetic energy of an airstream from the air intake port to the air output port into mechanical energy, the turbine comprising at least one adjustable vane for controlling an air flow resistance of the turbine,
an electrical generator coupled to the turbine for converting the mechanical energy into electrical energy, and
a controller for controlling a rotational speed of the turbine by controlling a quantity of electric power generated by the electrical generator, characterized in that the controller is configured to adapt the rotational speed of the turbine the air flow resistance of the turbine in such a way that a substantially optimal turbine efficiency is obtained.

2. An air inlet system as claimed in claim 1, wherein the controller is configured to adapt the rotational speed of the turbine in dependence of a position of the at least one adjustable vane.

3. An air inlet system as claimed in claim 1, wherein the controller comprises a sensor for determining the turbine efficiency, the controller and the sensor being part of a control loop for obtaining the substantially optimal turbine efficiency.

4. An internal combustion engine comprising a combustion chamber and an air inlet system as claimed in claim 1 for providing air for the combustion chamber.

5. A method of controlling an air inlet system according to claim 1, the method comprising a step of:
based on a preferred engine load, determining a required air flow resistance of the turbine,
adjusting a configuration of the at least one adjustable vane in dependence of the required air flow resistance,
based on the configuration of the at least one adjustable vane determining an optimal blade speed ratio in terms of turbine efficiency,
for obtaining or approaching the optimal blade speed ratio, controlling the rotational speed of the turbine by controlling the quantity of electric power generated by the electrical generator.

6. A method of controlling an air inlet system as claimed in claim 5, wherein the step of determining the optimal blade speed ratio comprises using a lookup table and wherein the method further comprises the steps of:
measuring a rotational speed and/or efficiency of the turbine,
updating the lookup table based on the measured rotational speed and/or efficiency.

7. A computer program product for controlling an air inlet system, which program is operative to cause a processor to perform the method as claimed in claim 5.
